(19) United States
(12) Patent Application Publication
(10) Pub. No.: US 2008/0232560 A1
(43) Pub. Date: Sep. 25, 2008

(54) Method and system to control IVR-IVR dialogue sessions

(76) Inventor: Eric R. Sirkin, Palo Alto, CA (US)

Correspondence Address: Lester H. Birnbaum, 6 Oakmont Court, Simpsonville, SC, 29681, US

(21) Appl. No.: 11/725,341

(22) Filed: Mar. 19, 2007

(51) Int. Cl. H04M 11/00

(52) U.S. Cl. 379/88.18

(57) ABSTRACT

The present invention relates to controlling progress of a dialogue session. The dialogue session is initiated by a calling Interactive Voice Response (IVR) either with a called IVR or with a called Voice Mail System (VMS). Various progress detectors are provided at the calling IVR to detect the progress at one or more steps of the dialogue session. Further, appropriate actions are executed based on the detected progress, for controlling the progress of the dialogue session. The detected progress is reported to a master application connected to the calling IVR. The master application controls the dialogue session based on the reported progress.

### BACKGROUND

The invention relates to the field of telecommunication, in general. More specifically, the invention relates to Interactive Voice Response (IVR) sessions.

With the advent of telecommunication, web browsers and telecommunication equipment are being increasingly used to facilitate telecommunication among users. Hereinafter, telecommunication equipment and web browsers are referred to as telecommunication systems. Examples of telecommunication equipment include, but are not limited to, mobile phones, telephones, modems, personal digital assistant (PDA), and so forth. A user can initiate a dialogue session with another user by making an outbound call through his telecommunication system. The user who initiates the dialogue session is hereinafter referred to as the calling party, whereas the user receiving the incoming call is hereinafter referred to as the called party.

In case the called party is unavailable, either a Voice Mail System (VMS) or an Interactive Voice Response (IVR) at the called party's telecommunication system responds to the incoming call from the calling party. The VMS and IVR at the called party's telecommunication system are hereinafter referred to as the called VMS and the called IVR respectively. The VMS and IVR are systems that provide automated communication between the called party and the calling party. The VMS allows calling parties to store their voice messages for the called party. The VMS includes a voice guided answering machine that stores and retrieves voice messages of a calling party. The VMS provides one-way interaction with the calling party as it cannot interpret the responses of the calling parties and only provides the service of storing their voice messages. On the other hand, the IVR can interpret the responses of the calling party and, therefore, facilitates two-way interaction with the calling party. The IVR is designed to communicate according to the responses of the calling party.

The VMS and IVR can be equipped with various automated processes such as automatic voice storing, automatic voice transmission, automatic voice recognition, among others, to obviate the need for human intervention at the telecommunication system of the calling party and/or called party. Further, the IVR and VMS are hosted by the mobile or landline phone carriers, and web servers of telecommunication systems.

In a typical dialogue session between a calling party and a called IVR/VMS, the called IVR/VMS plays pre-recorded prompts to offer a pre-defined menu to the calling party. The pre-defined menu includes a number of options that correspond to various actions that can be performed by the calling party during the dialogue session. The actions can include asserting Dual-Tone Multiple-Frequency (DTMF) keys using the keypad of the telecommunication system, playing a pre-recorded audio file, and so forth.

An IVR implemented at a calling party's telecommunication system is hereinafter referred to as the calling IVR. The calling IVR initiates a dialogue session either with the called IVR or called VMS. Similar to a dialogue session between a calling party and a called IVR/VMS, the called IVR/VMS offers the pre-defined menu to the calling IVR during the dialogue session. The pre-defined menu is in the form of a pre-recorded prompt of the called IVR/VMS. The calling IVR responds to the pre-recorded prompt in the form of a pre-defined response. The responses of the calling IVR are pre-defined according to the pre-recorded prompts of the called IVR. However, if changes are made in a pre-recorded prompt at a step of the dialogue session, then the calling IVR may not know about the change, and may respond according to the expected pre-recorded prompt at that step. As a result, there may be a communication gap between the calling IVR and the called IVR/VMS, and the dialogue session may not be successful. Moreover, if the calling IVR make an outbound call to a wrong called IVR/VMS, the calling IVR may not come to know about the wrong number during the dialogue session. As a result, the calling IVR would continue communicating with the wrong called IVR/VMS. Therefore, in light of the above discussion, conventional IVR-IVR and IVR-VMS dialogue sessions have limitations, as there is no method and system that enables the calling IVR to detect the progress at the steps performed by the called IVR/VMS and respond accordingly.

Hence, there exists a need for a method and system that detect the progress at each step of the dialogue session and maintain co-ordination between the calling IVR and the called IVR/VMS on the basis of the detected progress. Further, the method and system should determine whether each step of the dialogue session is successful or not. A need also exists for a method and system that can make dynamic changes in the steps of the calling IVR corresponding to the changes in the steps of the called IVR/VMS. Further, the method and system should also be able to control the dialogue session between the calling IVR and the called IVR/VMS.

### SUMMARY

An object of the present invention is to provide a method and system that enable the calling IVR to detect the progress of a dialogue session between a calling Interactive Voice Response (IVR) and a called IVR.

Another object of the present invention is to provide a method and system that enable the calling IVR to detect the progress of the dialogue session between the calling IVR and a called Voice Mail System (VMS).

Yet another object of the present invention is to provide a method and system that enable the calling IVR to control the progress of the dialogue session between the calling IVR and the called IVR or the called VMS on the basis of the detected progress.

Still another object of the present invention is to provide a method and system that enable the calling IVR to report the detected progress of a dialogue session to a master application.

Still another object of the present invention is to provide a method and system at the calling IVR for controlling the dialogue session between the calling IVR and the called IVR or called VMS on the basis of the reported progress.

Various embodiments of the present invention provide a method and system that enables the calling IVR to control the progress of a dialogue session. The dialogue session is initiated by the calling IVR, either with a called IVR or with a called VMS. The calling IVR is the IVR at a calling party's telecommunication system. The IVR and VMS implemented at a called party's telecommunication system are hereinafter collectively referred to as a called system. The dialogue session comprises different steps. The steps are performed by the calling IVR and the called system. The progress of the dialogue session is controlled by detecting the progress at steps that are performed by the called system, and executing actions at the calling party on the basis of the detected progress. The progress is detected using various progress detectors. Examples of a progress detector include, but are not limited to, tone detector, silence detector, automatic speech recognizer, and speech pattern recognizer. The executed actions form different steps of the calling IVR in the dialogue session. Therefore, each step that is to be performed by the calling IVR in the dialogue session can be decided on the basis of the detected progress of the called system. The process of detecting the progress at a step and executing an action on the basis of the detected progress of the step continues until the dialogue session is completed. The detected progress can be reported to a master application that is connected to the calling IVR. The reporting of the detected progress informs the master application of the progress of the dialogue session. When the dialogue session is completed/terminated, the master application receives the report of the overall progress of the dialogue session. On the basis of the report of the detected progress, the master application controls a successive dialogue session. The master application can either introduce one or more steps or modify some steps of the calling IVR for a successive dialogue session. Hence, all successive dialogue sessions can be modified on the basis of the detected progress of previous dialogue sessions so as to improve the reliability and performance of the calling IVR in the successive dialogue sessions.

### BRIEF DESCRIPTION OF THE DRAWINGS

Various embodiments of the present invention will hereinafter be described in conjunction with the appended drawings provided to illustrate and not to limit the invention, wherein like designations denote like elements, and in which:

FIG. 1 illustrates an exemplary environment, wherein various embodiments of the present invention can be practiced;

FIG. 2 is a block diagram that illustrates a calling IVR and a called IVR communicating with each other in a dialogue session, in accordance with various embodiments of the present invention;

FIG. 3 is a flowchart illustrating a method for controlling the progress of a dialogue session, in accordance with various embodiments of the present invention;

FIG. 4 is a flowchart illustrating a detailed method for controlling the progress of a dialogue session, in accordance with various embodiments of the present invention;

FIG. 5 is a block diagram that illustrates a calling IVR communicating with a master application, in accordance with various embodiments of the present invention; and

FIG. 6 is a flowchart illustrating a method for controlling a dialogue session, in accordance with various embodiments of the present invention.

### DETAILED DESCRIPTION OF THE INVENTION

Various embodiments of the present invention provide a method and system that enables a calling Interactive Voice Response (IVR) to control the progress of a dialogue session. The dialogue session is initiated by the calling IVR, with either a called IVR or a called VMS. The dialogue session comprises different steps. In a typical prior art dialogue session between a calling IVR and a called IVR, the calling IVR plays pre-recorded responses to pre-recorded prompts of the called IVR. The pre-recorded prompts are produced by the called IVR at different steps of the dialogue session. However, if there are dynamic changes in a pre-defined prompt of the called IVR at a step of the dialogue session, the calling IVR does not come to know about the dynamic changes during the step. As a result, the calling IVR responds to the step in the form of a pre-defined response. Various embodiments of the present invention provide a method and system that enable a calling IVR to detect the progress of each step that is performed by the called IVR and execute an action accordingly. Various embodiments of the present invention also provide a method and system for making changes in the steps of the calling IVR, on the basis of the detected progress at the steps of the called IVR. The changes in the steps of the calling IVR, on the basis of the detected progress at the steps of the called IVR, are useful in improving the reliability and performance of the calling IVR in current as well as a successive dialogue session. Although various embodiments of the present invention have been explained with respect to a dialogue session between a calling IVR and a called IVR, they are also applicable to a dialogue session between a calling IVR and a called VMS.

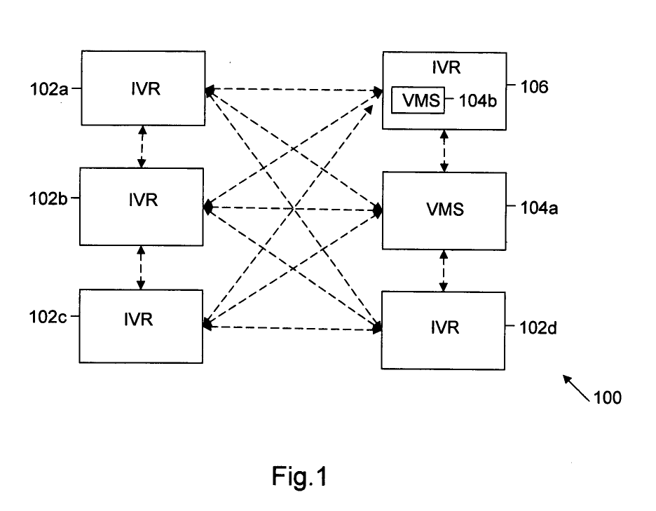

FIG. 1 illustrates an exemplary environment 100 wherein various embodiments of the present invention can be practiced. Environment 100 is only one example of a suitable environment and is not intended to suggest any limitation as to the scope of use or functionality of the subject matter disclosed herein. In addition, the number of IVR 102, IVR 106 and VMS 104a has been shown only as an example and is not intended to suggest any limitation as to the scope of use or functionality of the subject matter disclosed herein. Environment 100 includes Interactive Voice Response (IVR) 102a, 102b, 102c, 102d, hereinafter collectively referred to as IVR 102. Environment 100 further includes a Voice Mail System (VMS) 104a. IVR 102 and 106, and VMS 104a are automated systems that are implemented at the telecommunication systems of a number of users. Examples of a telecommunication system include, but are not limited to mobile phone, telephone, modem, personal digital assistant (PDA), and web browser. In accordance with an embodiment of the invention, IVR 102 and IVR 106 are hosted by an independent telecommunication service provider which initiates and controls IVR 102 and IVR 106. Further, VMS 104a may be hosted by mobile or landline phone carriers, and web servers of the telecommunication systems. A user initiates a dialogue session by making an outbound call to another user. The user who initiates the dialogue session is hereinafter referred to as a calling party, whereas the user who receives an incoming call for the dialogue session is hereinafter referred to as a called party.

IVR 102, IVR 106 and VMS 104a implemented at the telecommunication systems would perform the functions that human users would perform. IVR 102 and IVR 106 obviate the necessity of any human intervention at the telecommunication system of a calling party and/or a called party. IVR 102 and IVR 106 can make outbound calls on behalf of the calling party, and/or can manage incoming calls on behalf of the called party. Similarly, VMS 104a is an automated system that obviates the necessity of a user at the called party's telecommunication system. VMS 104a can receive incoming calls on behalf of the called party. VMS 104a includes a voice-guided answering machine that stores and retrieves voice messages at the called party's telecommunication system. In accordance with an embodiment of the present invention, IVR 102, IVR 106 and VMS 104a can be equipped with various automated processes such as automatic voice storing, automatic voice transmission, automatic voice recognition, Dual Tone Multiple Frequency (DTMF) tone recognition, DTMF tone insertion, and so forth, to automatically manage the incoming and outbound calls. In accordance with an embodiment of the present invention, IVR 106 includes VMS 104b. Hence, IVR 106 includes the integrated functionalities of VMS and IVR technologies. In accordance with an embodiment of the present invention, the characteristics and the functions of VMS 104b are similar to those of VMS 104a.

In accordance with an embodiment of the present invention, IVR 102 and IVR 106 can automatically make outbound calls. On the other hand, IVR 102, IVR 106, and VMS 104a can automatically manage incoming calls. For example, IVR 102a can automatically make outbound calls to at least one of IVR 102b, 102c, 102d, 106 and VMS 104a. In accordance with an embodiment of the present invention, IVR 102a makes an outbound call to IVR 106 to initiate a dialogue session with IVR 106. The purpose of making the outbound call may include, but is not limited to, leaving a voice message for the called party of IVR 106, selecting a music file, and receiving information from IVR 106. In response to the incoming call, IVR 106 plays pre-recorded prompts to offer a pre-defined menu to IVR 102a. The pre-defined menu may include a number of options. The options correspond to actions that can be performed by IVR 102a. The actions may include, but are not limited to, asserting Dual-Tone Multiple-Frequency (DTMF) keys by using the keypad of an associated telecommunication system, playing a pre-recorded audio file, and playing a text to speech prompt.

A person of ordinary skill in the art will understand that it may not be required, but has been assumed for the purpose of explaining the invention, that IVR 102a understands the pre-defined menu of IVR 106. For example, IVR 102a knows that IVR 106 may play a pre-recorded welcome message for IVR 102a when the dialogue session is initiated between them. In addition, IVR 102a understands each of the pre-recorded prompts of IVR 106. Also, IVR 102a may know the time delays between the pre-recorded prompts of IVR 106. In accordance with an embodiment of the present invention, IVR 102a includes a set of pre-defined responses to respond to the pre-recorded prompts of IVR 106. The responses are pre-defined on the basis of the pre-recorded prompts of IVR 106, for facilitating a dialogue session between IVR 102a and IVR 106.

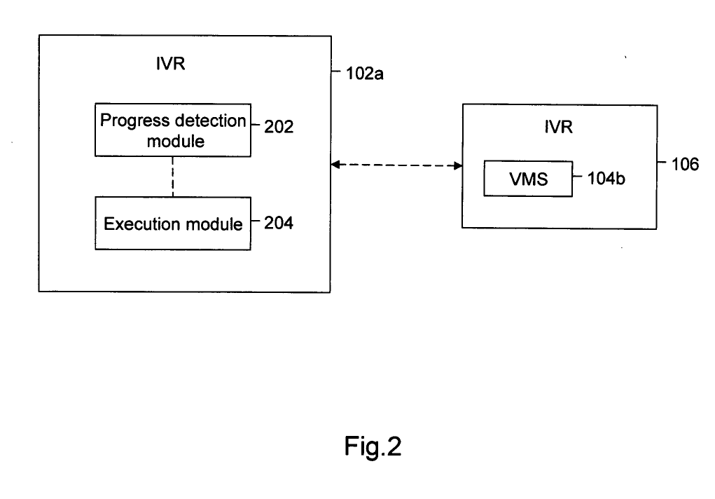

FIG. 2 is a block diagram that illustrates IVR 102a and IVR 106 communicating with each other in a dialogue session, in accordance with various embodiments of the present invention. IVR 102a is hereinafter referred to as a calling IVR, as it initiates the dialogue session by making an outbound call. Similarly, IVR 106 is hereinafter referred to as a called IVR, as it receives an incoming call from the calling IVR. In accordance with FIG. 1, it will be understood that IVR 102a can also initiate a dialogue session with VMS 104a. VMS 104a is hereinafter referred to as a called VMS, as it can receive an incoming call from the calling IVR. On receiving the incoming call, VMS 104a can offer a pre-defined menu to IVR 102a. Various embodiments of the present invention that have been explained with respect to a dialogue session between the calling IVR and the called IVR, are also applicable to a dialogue session between the calling IVR and the called VMS. However, for the purpose of explaining the invention, the dialogue session between the calling IVR and the called IVR is illustrated. As mentioned above, the called IVR includes the integrated functionalities of IVR and VMS technologies.

The dialogue session between the calling IVR and the called IVR comprises one or more steps. For example, when the calling IVR makes the outbound call to the called IVR, the called IVR plays a pre-recorded welcome message for the calling IVR. The utterance of the pre-recorded welcome message is considered as a step of the dialogue session, which is being performed by the called IVR. In accordance with various embodiments of the present invention, the calling IVR anticipates the playing of the pre-recorded welcome message by the called IVR when the dialogue session is initiated. The calling IVR is designed to respond in the form of a pre-defined response to the pre-recorded welcome message. In accordance with an embodiment of the present invention, the pre-recorded welcome message may include an option for the calling IVR to record a voice message after hearing a beep. The beep is produced by the called IVR after the pre-recorded welcome message is played. The utterance of the beep is also one of the steps of the dialogue session that is performed by the called IVR.

The calling IVR executes an action in response to a step performed by the called IVR. The executed action is decided on the basis of the progress detected at the step of the called IVR. The process of detecting the progress at the step includes detecting whether the step performed by the called IVR is similar to a pre-defined step of the called IVR. For example, utterance of the beep is a pre-defined step that is to be performed by the called IVR, after the pre-recorded welcome is played. The calling IVR executes an action on the basis of the detection of the beep. The process of detecting the progress at the steps performed by the called IVR and executing actions controls the progress of the dialogue session.

Referring to FIG. 2, the calling IVR includes a progress detection module 202 and an execution module 204. Progress detection module 202 and execution module 204 together control the progress of the dialogue session. Progress detection module 202 detects the progress at one or more steps that are performed by the called IVR. Further, execution module 204 uses the detected progress to execute actions at the calling IVR. Examples of the actions executed by execution module 204, include, but are not limited to, selecting a pre-defined response from the set of pre-defined responses, restarting the dialogue session, restarting one or more steps of the dialogue session, enabling progress detection at the successive steps, disabling progress detection at the successive steps, and terminating the dialogue session. Examples of a pre-defined response include, but are not limited to, playing a pre-recorded audio file, introducing a pause, recognizing DTMF tones, and asserting DTMF tones.

Progress detection module 202 uses multiple progress detectors to detect the progress at steps that are performed by the called IVR. Examples of a progress detector include, but are not limited to, tone(s) detector, silence detector, automatic speech recognizer, and speech pattern recognizer. Each of the progress detectors can be used to indicate the occurrence of steps that are performed by the called IVR.

A tone detector can detect a single tone, multi-frequency tone or a set of tones, generated by the called IVR, for a sustained period. The set of tones may be a combination of tones of multiple frequencies. Tone detection can be used to determine the occurrence of a tone-generating step that is performed by the called IVR in the dialogue session. Further, a silence detector can detect a sustained period of silence produced by the called IVR in the dialogue session. The length of the silence and its time proximity to other steps can be used to detect the occurrence of a silence-generating step of the called IVR. Further, an automatic speech recognizer can be used to detect the contents of a dialogue, wherein the dialogue is uttered at a step by the called IVR. In accordance with an embodiment of the present invention, when the called IVR plays the pre-recorded welcome message for the calling IVR, the automatic voice recognizer detects all the content of the pre-recorded welcome message. In accordance with another embodiment of the present invention, the automatic voice recognizer detects some portion of the pre-recorded welcome message. Further, a speech pattern recognizer can detect specific audible frequency and tonal patterns uttered by the called IVR in the dialogue.

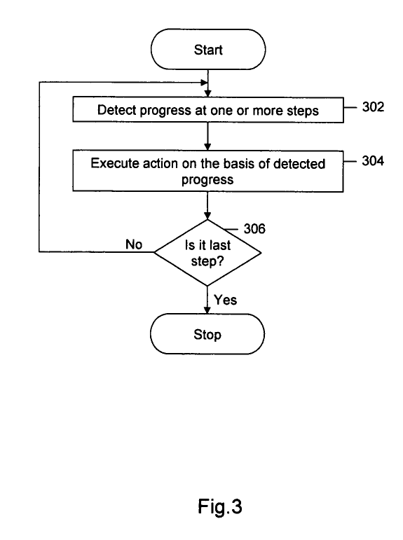

FIG. 3 is a flowchart illustrating a method for controlling the progress of a dialogue session between the calling IVR and the called IVR, in accordance with an embodiment of the present invention. The progress of the dialogue session can be controlled by using different types of progress detectors and an execution module. The flowchart of FIG. 3 will hereinafter be explained in conjunction with FIG. 2. At step 302, progress detection module 202 detects the progress at steps that are performed by the called IVR. As explained above, multiple progress detectors can be used to detect the progress at the steps that are performed by the called IVR. On the basis of the detected progress, execution module 204 executes an action at step 304. The examples of executed action have been explained in conjunction with FIG.2. The process of detecting the progress and executing an action is continued until the last step of the dialogue session is reached. At step 306, it is checked if the dialogue session has reached the last step. If the dialogue session has not reached the last step, then the process of detecting the progress and executing an action as shown in steps 302 and 304 is repeated for successive steps of the called IVR.

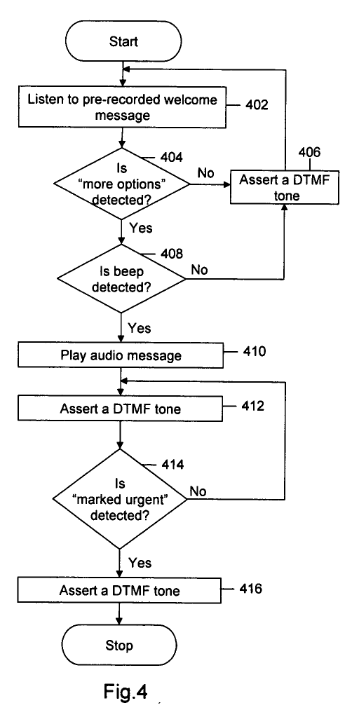

The method for controlling the progress of a dialogue session between the calling IVR and the called IVR is explained in detail with the help of a flowchart illustrated in FIG. 4. The flowchart illustrates a dialogue session in which the calling IVR leaves a voice message for the called IVR.

FIG. 4 is a flowchart illustrating a detailed method for controlling the progress of a dialogue session between the calling IVR and the called IVR, in accordance with various embodiments of the present invention. The flowchart of FIG.4 will hereinafter be explained in conjunction with FIG.2. The dialogue session is initiated by the calling IVR. In the dialogue session, the calling IVR is aware of the pre-defined menu of the called IVR, and is designed to respond according to the prompts of the pre-defined menu. For example, the calling IVR is already aware of the contents of a pre-recorded welcome message of the called IVR and is designed to respond according to the pre-recorded welcome message. At step 402, the calling IVR listens to the pre-recorded welcome message produced by the called IVR. In accordance with an embodiment of the present invention, the pre-recorded welcome message states “Your call has been forwarded to an automated voice response. Please record your voice message after the beep. When you are done, press the # key for more options”. The called IVR is designed to play a beep to indicate that the called IVR will start recording the voice message at the beep. Since the beginning of the dialogue session, the calling IVR is at pause. The duration of the pause of the calling IVR is determined on the basis of detection of utterance of “more options” in the pre-recorded welcome message.

The utterance of “more options” indicates that the complete pre-recorded welcome message has been played by the called IVR. At step 404, a progress detector such as an automatic speech recognizer detects if “more options” has been uttered in the pre-recorded welcome message. If the automatic speech recognizer does not detect “more options”, execution module 204 extends the pause at the calling IVR and attempts to listen to the pre-recorded welcome message again. Further, execution module 204 may assert a DTMF tone at step 406 which causes the called IVR to replay the pre-recorded welcome message. In accordance with another embodiment of the present invention, execution module 204 may ignore the detection of “more options” and proceeds to the next step without re-attempting to listen to the pre-recorded welcome message.

In accordance with an embodiment of the present invention, when the automatic speech recognizer detects “more options”, execution module 204 terminates the pause of the calling IVR and executes an action that enables the detection of the beep. In accordance with another embodiment of the present invention, execution module 204 decides to ignore the detection of “more options”, terminates the pause of the calling IVR, and executes the action of enabling detection of the beep. Next, at step 408, a progress detector such as a tone detector detects if the beep has been uttered. In case the tone detector does not detect the beep, execution module 204 performs step 406 that causes the called IVR to replay the pre-recorded welcome message. In accordance with an embodiment of the present invention, execution module 204 may perform step 406 after a period of listening to silence instead of the beep. A period of listening to silence after the pre-recorded welcome message may likely indicate that the called IVR is ready for the recording of the voice message. In accordance with an embodiment of the present invention, execution module 204 may ignore the detection of the beep and proceeds with playing the voice message at step 410. In accordance with an embodiment of the present invention, the calling IVR plays the voice message by playing a pre-recorded audio file. The pre-recorded audio file includes the voice message and is possessed by the calling IVR prior to the dialogue session.

In accordance with an embodiment of the present invention, when the tone detector detects the beep, execution module 204 starts playing the voice message at step 410. The called IVR records the voice message as the voice message is being played by the calling IVR. Further, when the complete voice message is played, execution module 204 asserts DTMF tone “#” at step 412. The assertion of DTMF tone “#” at step 412 indicates to the called IVR that the complete voice message has been played and the called IVR may stop the recording process.

Further, after identifying DTMF tone “#”, the called IVR may offer a list of options to the calling IVR. The calling IVR is at pause during the utterance of the list of options. The calling IVR is already aware of the list of options offered by the called IVR and is designed to assert a DTMF tone after the utterance of the complete list of options. In accordance with an embodiment of the present invention, the list of options may state “Press 1 to listen to your recording, 2 to record again, 3 to send it as normal delivery or 4 to send it marked urgent”. In accordance with an embodiment of the present invention, the utterance “send to as normal delivery” means the recorded voice message should be sent to the called party. Further, the utterance “send it marked urgent” means that the recorded voice message should be urgently sent to the called party.

Further, the utterance of “marked urgent” indicates that the complete list of options has been uttered by the called IVR. At step 414, the automatic voice recognizer detects if “marked urgent” has been uttered in the list of options. If automatic voice recognizer does not detect “marked urgent”, then it may be possible that the called IVR have made some changes in the list of options. In such case, execution module 204 may assert a DTMF tone for replaying the list of options. Also, execution module 204 may assert a DTMF tone that causes the called IVR to replay the pre-recorded welcome message. Further, in accordance with an embodiment of the present invention, execution module 204 may assert a DTMF tone for terminating the current dialogue session.

Further, if execution module 204 detects “marked urgent”, then calling IVR understands that the complete list of options has been uttered and it is the right time to assert a DTMF tone. Therefore, at step 416, execution module 204 asserts a DTMF tone. In accordance with an embodiment of the present invention, execution module 204 asserts DTMF tone “3” at step 416, to acknowledge to the called IVR that the calling IVR wishes the recorded voice message to be sent to the called party normally. In accordance with an embodiment of the present invention, the called party may be communicating with the called IVR to receive the recorded voice message. In accordance with another embodiment of the present invention, the called IVR can store the recorded voice message. The stored recorded voice message can be accessed later by the called party.

In accordance with another embodiment of the present invention, execution module 204 may assert DTMF tone “1” at step 416 to listen to the recorded voice message. The calling IVR generally requests the playback of the recorded voice message, so as to determine whether the voice message was recorded successfully. The recording is determined by using a unique tone that is either pre-pended or appended or inserted by the calling IVR, into the voice message prior to the recording. The unique tone is only used for determining whether the recording was done successfully. It may not include any useful data for the called party, and hence, the unique tone can either be audible or inaudible to a human ear. Further, the unique tone can either be a single tone or a set of tones. When the called IVR playbacks the recorded voice message, a progress detector waits for the unique tone in the recorded voice message. If the unique tone is detected successfully, then the calling IVR concludes that the recording of the voice message was done successfully. If the unique tone is not detected, then execution module 204 can execute an action of asserting DTMF tone “2” at step 416, for recording the voice message again.

In accordance with another embodiment of the present invention, more than one progress detector can be used to determine the progress at one step of the dialogue session. The use of more than one progress detector to detect progress at one step facilitates fault tolerance at the calling IVR. If one progress detector fails to detect the progress at a step, the other progress detector can determine the progress at that step. For example, the tone detector waits for the beep from the called IVR at step 406 after the completion of the pre-recorded welcome message. If the tone detector could not detect the beep at step 406, due to a system failure at the calling IVR, then the silence detector can be used as a back up progress detector for detecting the silence after the pre-recorded welcome message is played. There is typically a long period of silence after the pre-recorded welcome message, while the called IVR tries to record the voice message. The detection of silence can be used to indicate that the called IVR is ready to record the voice message after the pre-recorded welcome message is played. Hence, two progress detectors are used to determine the progress at a single step of the dialogue session.

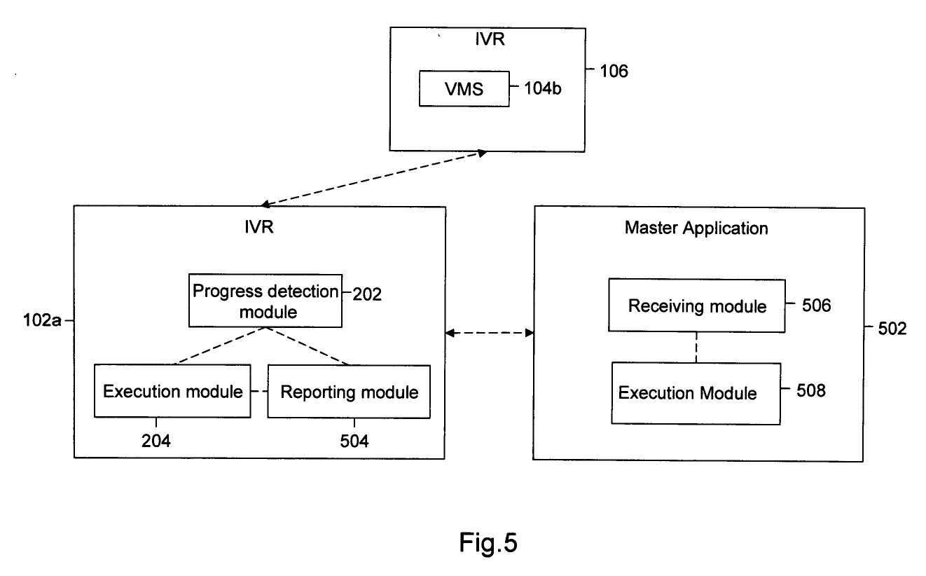

In accordance with another embodiment of the present invention, a failure in detecting the progress at a step of the dialogue session can be used to conclude that an error has occurred at the step. For example, if the automatic speech recognizer could not detect the entire pre-recorded welcome message when the dialogue session was initiated, then there may be a possibility that the calling IVR has made the outbound call to a wrong IVR. Further, there may be a possibility that the called IVR could have changed the pre-recorded welcome message or introduced a new step before the playing of the pre-recorded welcome message. In such cases, execution module 204 may execute an action to either restart the dialogue session or correct the error. For example, execution module 204 may execute the action of reporting the error to a master application connected to the calling IVR. On the basis of the error report, the master application can control the dialogue session. The step of controlling the dialogue session includes making a decision regarding the dialogue session. For example, controlling the dialogue session may include re-starting the dialogue session after terminating the current dialogue session. The communication of the calling IVR with the master application has been illustrated in FIG. 5.

FIG. 5 illustrates the calling IVR communicating with a master application 502 to report the detected progress of the dialogue session to master application 502, in accordance with various embodiments of the present invention. Master application 502 is a program that controls the calling IVR. In accordance with an embodiment of the present invention, master application 502 is a program running on a server that may be externally connected to the calling IVR. The server may also be communicating with the calling party through a connected computing device. Examples of the connected computing device include, but are not limited to, personal computer web browser, Internet enabled mobile phone, and Internet connected Personal Digital Assistant (PDA).

The calling IVR includes a reporting module 504 along with progress detection module 202 and execution module 204. Reporting module 504 reports the detected progress of the dialogue session to master application 502. In accordance with an embodiment of the invention, reporting module 504 reports whether the dialogue session was successful or not. Also, reporting module 504 can dynamically report the detected progress of each step of the dialogue session during the dialogue session itself. In the report, reporting module 504 may inform about the success and failure of each step of the dialogue session. In accordance with an embodiment of the present invention, reporting module 504 can create logs of each dialogue session in a database at master application 502. The database can be used as a learning tool to dynamically change the steps of the calling IVR in successive dialogue sessions.

Master application 502 includes a receiving module 506 and an execution module 508. Receiving module 506 and execution module 508 together control the dialogue session. Receiving module 506 receives the report of the detected progress of the dialogue session from reporting module 504. Execution module 508 executes an action on the basis of the report received from reporting module 504. Examples of executing an action include, but are not limited to, notifying the detected progress to the calling party, making a decision regarding restarting the dialogue session if the dialogue session was a failure, modifying at least one step of the calling IVR, introducing at least one step at the calling IVR, or any combination thereof.

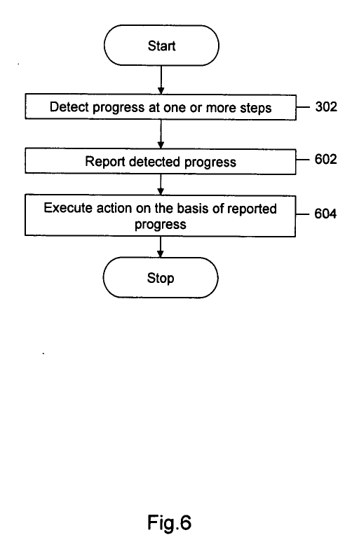

The method of controlling the dialogue session by using receiving module 506 and execution module 508 has been explained in detail with reference to FIG.6.

FIG. 6 is a flowchart illustrating a method for controlling the dialogue session by master application 502, in accordance with various embodiments of the present invention. The flowchart of FIG. 6 will hereinafter be explained in conjunction with FIG. 5 and FIG. 3. As already explained at step 302, progress detection module 202 detects the progress at one or more steps of the dialogue session. At step 602, reporting module 504 reports the detected progress to receiving module 506. Reporting module 504 can dynamically report the detected progress during the dialogue session. Further, reporting module 504 can report the overall success or failure of the dialogue session after the completion of the dialogue session.

Further, at step 604, execution module 508 executes an action on the basis of the reported progress. For example, if receiving module 506 receives a report that the dialogue session has failed, then execution module 508 decides whether the dialogue session should be restarted. If execution module 508 decides to restart the dialogue session, then execution module 508 decides whether the dialogue session should be restarted after modifying some steps of the calling IVR. Also, execution module 508 decides whether one or more steps should be introduced at the calling IVR before restarting the dialogue session.

Further, if receiving module 506 receives a report that the dialogue session has failed at some steps, then execution module 508 may modify at least one step of the calling IVR and restart the dialogue session. Examples of modifying the steps of the calling IVR, include, but are not limited to, modifying duration of pauses, changing timings between DTMF tone assertions, changing DTMF tone assertions, changing a text within a text-to-speech prompt, playing different pre-recorded audio file(s), or any combination thereof. In accordance with an embodiment of the present invention, execution module 508 modifies the steps of the calling IVR during the dialogue session. In accordance with another embodiment of the present invention, execution module 508 modifies the steps of the calling IVR after the dialogue session is completed/terminated.

Further, execution module 508 can introduce one or more steps at the calling IVR on the basis of the reported progress of the dialogue session. Examples of introducing the steps at the calling IVR include, but are not limited to, introducing additional pauses, inserting DTMF tones, adding audio files in the dialogue session, or any combination thereof. In accordance with an embodiment of the present invention, execution module 508 introduces a step at the calling IVR during the dialogue session. In accordance with another embodiment of the present invention, execution module 508 introduces at least one step at the calling IVR after the dialogue session is completed/terminated.

In accordance with an embodiment of the present invention, when the calling party communicates with a server through the connected computing device, then introducing a step further includes adding a live recording from the calling party during the dialogue session. The calling party can record his/her voice, by using a microphone connected to the connected computing device. The calling party can send his/her voice via streaming from a web browser, which is communicating with the server. The server dynamically sends the live recording to the calling IVR. The calling IVR receives the live recording and introduces it in the dialogue session. In accordance with another embodiment of the present invention, execution module 508 can dynamically record the voice of the calling party by initiating a conference call with the calling party. The conference call includes the calling IVR, the called IVR and the calling party. The calling party dynamically records his/her voice in the conference call.

Further, introducing a step includes initiating an external process, such as adding another IVR session into the dialogue session. In accordance with an embodiment of the present invention, the added IVR session is at least one of IVR 102b, 102c, 102d, and VMS 104a in conjunction with FIG. 1. In accordance with another embodiment of the present invention, introducing a step includes introducing manual calling in the dialogue session. For example, if receiving module 506 receives a report that the calling IVR is not able to interpret the pre-recorded prompts of the called IVR and is facing difficulty in moving further in the dialogue session, then execution module 508 may initiate the manual calling in the dialogue session. In accordance with another embodiment of the present invention, execution module 508 can initiate the manual calling in a dialogue session successive to the dialogue session.

The modified and introduced steps of the calling IVR may be useful in improving the reliability and performance of the calling IVR in a dialogue session successive to the dialogue session. In accordance with an embodiment of the present invention, the successive dialogue session is a new dialogue session initiated after successful completion of the dialogue session. In accordance with another embodiment of the present invention, the successive dialogue session is initiated by restarting the dialogue session, if the dialogue session was a failure. In accordance with yet another embodiment of the present invention, the successive dialogue session may include the modified and introduced steps of the calling IVR. In accordance with yet another embodiment of the present invention, the successive dialogue session may not include the modified and introduced steps of the calling IVR.

In accordance with various embodiments of the present invention, the method and system used for controlling the progress of a dialogue session at the calling IVR are implemented in the form of a control application at the calling IVR. In accordance with an embodiment of the present invention, the control application is an XML code. The XML code communicates with the called IVR and controls the progress of the dialogue session. The execution of the XML code is a parent process of the dialogue session.

Further, the XML code comprises one or more branches. The progress detectors correspond to conditional statements in the XML code that are used for providing conditional branch designs in the XML code. The branches in the XML code correspond to various actions that can be executed at the calling IVR. On the basis of the result of the progress detectors, a branch of the XML code can be triggered. The triggering of the branch of the XML code corresponds to executing an action by execution module 204.

Further, the XML code includes Hyper Text Transfer Protocol (HTTP) posts that correspond to reports of the detected progress. In accordance with an embodiment of the present invention, the XML code may include File Transfer Protocol (FTP) posts. The HTTP and FTP posts are used for reporting the detected progress to master application 502. The HTTP and FTP posts use error codes for facilitating the process of reporting the detected progress to master application 502. Further, a person of ordinary skill in the art will understand that the present invention may use protocols other than HTTP and FTP for reporting the detected progress to master application 502. The HTTP and FTP have been mentioned here only for the purpose of explaining an embodiment of the present invention.

On the basis of the detected progress, master application 502 terminates the dialogue session, restarts the dialogue session, or spawns one or more child processes in the XML code. The spawning of the child processes in the XML code modifies the XML code. The spawning of a child process in the XML code corresponds to an action executed by execution module 508. The spawning of the child process also corresponds to adding a new process in the parent process of the dialogue session.

In accordance with an embodiment of the present invention, master application 502 spawns one or more child processes in the XML code after the dialogue session is completed/terminated. Hence, the XML code is modified after the completion/termination of the dialogue session. The modified XML code can be used to control the progress of successive dialogue sessions. Further, the modified XML code can be used to either restart or terminate a dialogue session on the basis of progress detected at one or more steps of the dialogue session.

In accordance with another embodiment of the present invention, master application 502 dynamically modifies the XML code by spawning one or more child processes in the XML code during the dialogue session. The child processes that are spawned during the dialogue session become part of the parent process of the dialogue session.

In accordance with an embodiment of the present invention, master application 502 can spawn a child session by redirecting control to a child XML process, thereby ending the parent process. The child session may correspond to a different dialogue session. For example, master application 502 may terminate the dialogue session and start an altogether new session, hereinafter referred to as a child session. In accordance with another embodiment of the present invention, master application 502 can spawn the child session by redirecting control to a process that uses a different programming language, and can generate the XML code as part of the child session. An example of the different programming language includes, but is not limited to, Java.

In accordance with various embodiments of the present invention, the calling IVR detects whether some changes have been made to the pre-recorded prompts and the pre-defined menu of the called IVR.

In accordance with various embodiments of the present invention, the calling IVR determines that the dialogue session is not successful if the calling IVR makes the outbound call to a wrong called IVR.

In accordance with various embodiments of the present invention, the calling IVR determines the step the dialogue session has reached.

In accordance with various embodiments of the present invention, the calling IVR responds to a step of the called IVR after detecting the progress at that step in the dialogue session.

In accordance with various embodiments of the present invention, a master application controls the dialogue session and makes continual improvements in successive dialogue sessions on the basis of information gathered from the dialogue session.

Various embodiments of the present invention provide a method and system for creating specialized automated IVR testing equipment. The calling IVR can be used as an automated IVR testing equipment for an IVR to be tested. The calling IVR initiates a dialogue session with the IVR under test, and generates speech and DTMF tones for the IVR under test. The calling IVR waits for predefined time periods and measures the responses made by the IVR under test at different steps of the dialogue session. The responses of the IVR under testing can further be modified or enhanced for future dialogue sessions.

Various embodiments of the present invention provide a method and system for managing and controlling IVR-IVR sessions for a corporate voice mail system. The corporate voice mail system is often used in association with a Corporate Branch Exchange PBX phone system within an enterprise.

Various embodiments of the present invention provide a method and system for managing and controlling IVR-IVR sessions for a Carrier Grade Voice Mail System. The Carrier Grade Voice Mail System is maintained and hosted by a telephony carrier in order to serve its customers.

Various embodiments of the present invention provide a method and system for managing and controlling IVR-IVR sessions that are used to provide information, products, services and support to customers and employees.

Various embodiments of the present invention provide a method and system for managing and controlling IVR-IVR sessions for a home-answering machine.

The system for controlling the progress of a dialogue session between IVR, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive, optical-disk drive, etc. The storage device may also be other similar means for loading computer programs or other instructions into the computer system. The computer system also includes a communication unit. The communication unit allows the computer to connect to other databases and the Internet through an Input/Output (I/O) interface, allowing the transfer as well as reception of data from other databases. The communication unit may include a modem, an Ethernet card, or any other similar device, which enables the computer system to connect to databases and networks, such as LAN, MAN, WAN and the Internet. The computer system facilitates inputs from a user through an input device, accessible to the system through an I/O interface.

The computer system executes a set of instructions that are stored in one or more storage elements, in order to process input data. The storage elements may also hold data or other information as desired. The storage element may be in the form of an information source or a physical memory element present in the processing machine.

The programmable instructions may include various commands that instruct the processing machine to perform specific tasks such as the steps that constitute the method of the present invention. The method and systems described can also be implemented using only software programming or using only hardware or by a varying combination of the two techniques. The present invention is independent of the programming language used and the operating system in the computers. The instructions for the invention can be written in all programming languages including, but not limited to ‘C’, ‘C++’, ‘Visual C++’ and ‘Visual Basic’. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine. The invention can also be implemented in all operating systems and platforms including, but not limited to, ‘Unix’, ‘DOS’, and ‘Linux’.

The programmable instructions can be stored and transmitted on computer readable medium. The programmable instructions can also be transmitted by data signals across a carrier wave. The present invention can also be embodied in a computer program product comprising a computer readable medium, the product capable of implementing the above methods and systems, or the numerous possible variations thereof. While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for controlling progress of a dialogue session, the dialogue session being initiated by a calling Interactive Voice Response (IVR), the dialogue session comprising one or more steps, the progress of the dialogue session being controlled at the calling IVR, the method comprising the steps of:
a. detecting progress of the dialogue session, the progress being detected at the one or more steps; and
b. executing an action on the basis of the detected progress, the executed action controlling the progress of the dialogue session at the one or more steps, the action being executed at the calling IVR.

2. The method of claim 1, wherein the dialogue session takes place between the calling IVR and a called IVR.

3. The method of claim 1, wherein the dialogue session takes place between the calling IVR and a called Voice Mail System (VMS).

4. The method of claim 1, wherein the step of detecting progress is selected from the group consisting of detecting silence, detecting a tone, automatic speech recognition, and speech pattern recognition.

5. The method of claim 4, wherein the step of detecting a tone comprises the step of detecting a set of tones, the set of tones being a combination of tones of multiple frequencies.

6. The method of claim 1 further comprising at least one of inserting, pre-pending and appending a unique tone into an audio file, the audio file being played for the purpose of recording by the called IVR, the unique tone facilitating the determination of success of the recording of the audio file.

7. The method of claim 6, wherein the unique tone is inaudible to a human ear.

8. The method of claim 6, wherein the unique tone is audible to a human ear.

9. The method of claim 1, wherein the step of executing the action comprises at least one of restarting the dialogue session, restarting the one or more steps of the dialogue session, and selecting a pre-defined response from a set of pre-defined responses.

10. A method for controlling a dialogue session, the dialogue session being initiated by a calling Interactive Voice Response (IVR), the dialogue session comprising one or more steps, the dialogue session being controlled at the calling IVR, the method comprising the steps of:
a. detecting progress of the dialogue session, the progress being detected at the one or more steps;
b. reporting the detected progress to a master application, the master application being connected to the calling IVR; and
c. executing an action on the basis of the reported progress, the action being executed by the master application, the executed action controlling the dialogue session.

11. The method of claim 10, wherein the dialogue session takes place between the calling IVR and a called IVR.

12. The method of claim 10, wherein the dialogue session takes place between the calling IVR and a called Voice Mail System (VMS).

13. The method of claim 10, wherein the step of executing the action comprises at least one of notifying the detected progress to a calling party, making a decision regarding restarting of the dialogue session, modifying the one or more steps of the dialogue session, and introducing one or more steps in the dialogue session.

14. The method of claim 13, wherein the step of modifying the one or more steps is at least one of modifying duration of pauses, changing timings between Dual-Tone Multiple-Frequency (DTMF) tone assertions, changing the DTMF tone assertions, changing text within a text-to-speech prompt, and playing a different audio file.

15. The method of claim 13, wherein the step of introducing the one or more steps is at least one of introducing additional pauses, inserting the DTMF tones, and adding audio files.

16. The method of claim 13 further comprising modifying one or more steps of a successive dialogue session on the basis of the reported progress of the dialogue session.

17. The method of claim 13 further comprising introducing one or more steps in a successive dialogue session on the basis of the reported progress of the dialogue session.

18. A system for controlling a dialogue session, the dialogue session being initiated by a calling Interactive Voice Response (IVR), the dialogue session comprising one or more steps, the dialogue session being controlled at the calling IVR, the system comprises:
a. a progress detection module, the progress detection module comprising at least one progress detector, the at least one progress detector detecting progress of the dialogue session, the progress being detected at the one or more steps; and
b. an execution module, the execution module executing an action on the basis of the detected progress, the executed action controlling the progress of the dialogue session at the one or more steps, the action being executed at the calling IVR.

19. The system of claim 18, further comprising:
a. a reporting module, the reporting module reporting the detected progress of the dialogue session; and
b. a master application, the master application receiving a report of the detected progress from the reporting module, the master application controlling the dialogue session on the basis of the report.

20. The system of claim 19, wherein the master application comprises:
a. a receiving module receiving the report of the detected progress; and
b. an execution module executing an action on the basis of the reported progress, the executed action controlling the dialogue session.

21. The system of claim 18, wherein the dialogue session takes place between the calling IVR and a called IVR.

22. The system of claim 18, wherein the dialogue session takes place between the calling IVR and a called Voice Mail System (VMS).

23. The system of claim 18, wherein the progress detector is selected from the group of a tone detector, a silence detector, an automatic speech recognizer, and a speech pattern recognizer.

24. A system for controlling progress of a dialogue session, the dialogue session being initiated by a calling Interactive Voice Response (IVR), the dialogue session comprising one or more steps, the progress of the dialogue session being controlled at the calling IVR, the system comprising:
a. means for detecting progress of the dialogue session, the progress being detected at the one or more steps; and
b. means for executing an action on the basis of the detected progress, the executed action controlling the progress of the dialogue session at the one or more steps, the action being executed at the calling IVR.

25. The system of claim 24, wherein the dialogue session takes place between the calling IVR and a called IVR.

26. The system of claim 24, wherein the dialogue session takes place between the calling IVR and a called Voice Mail System (VMS).

27. A system for controlling a dialogue session, the dialogue session taking place between a calling Interactive Voice Response (IVR) and a called IVR, the dialogue session comprising one or more steps, the dialogue session being controlled at the calling IVR, the system comprising:
a. means for detecting progress at the one or more steps of the dialogue session;
b. means for reporting the detected progress to a master application, the master application being connected to the calling IVR; and
c. means for executing an action on the basis of the reported progress, the executed action controlling the dialogue session.

28. A computer program product embodied in a computer readable medium, for controlling progress of a dialogue session, the dialogue session taking place between a calling Interactive Voice Response (IVR) and a called IVR, the dialogue session comprising one or more steps, the progress of the dialogue session being controlled at the calling IVR, the computer program product comprising:
a. program instructions for detecting progress of the dialogue session, the progress being detected at the one or more steps; and
b. program instructions for executing an action on the basis of the detected progress, the executed action controlling the progress of the dialogue session at the one or more steps, the action being executed at the calling IVR.

29. A computer program product embodied in a computer readable medium, for controlling a dialogue session, the dialogue session taking place between a calling Interactive Voice Response (IVR) and a called IVR, the dialogue session comprising one or more steps, the dialogue session being controlled at the calling IVR, the computer program product comprising:
a. program instructions for detecting progress at the one or more steps of the dialogue session;
b. program instructions for reporting the detected progress to a master application, the master application being connected to the calling IVR; and
c. program instructions for executing an action on the basis of the reported progress, the action being executed by the master application, the executed action controlling the dialogue session.
